(19) United States
(12) Patent Application Publication
(10) Pub. No.: US 2007/0273113 A1
(43) Pub. Date: Nov. 29, 2007

(54) Work Station Insert for Shopping Cart

(76) Inventor: Glen Muir, Bowie, MD (US)

Correspondence Address: SHOEMAKER AND MATTARE, LTD, 10 POST OFFICE ROAD - SUITE 110, SILVER SPRING, MD, 20910, US

(21) Appl. No.: 11/751,870

(22) Filed: May 22, 2007

Related U.S. Application Data
(60) Provisional application No. 60/803,297, filed on May 26, 2006.

(51) Int. Cl. B62D 39/00

(52) U.S. Cl. 280/33.992

(57) ABSTRACT

A work station insert for a shopping cart has a large table top useful for writing on, and storage drawer beneath the table top. The insert hooks over the push handle of the cart, so that the insert cannot move rearward or tip forward; it is supported near its center by the seat back of a cart having a folding child seat, or by a tube which supports the back of a fixed seat. The storage drawer can be pulled out forward from beneath the table top, and a trash deflector is provided beneath a cutout at the rear of the table top to direct trash into the shopping cart receptacle. Alternative embodiments are provided for different styles of shopping carts.

This application claims benefit of provisional U.S. patent application No. 60/803,297 filed May 26, 2006.

### BACKGROUND OF THE INVENTION

This invention relates to an insert for a basket-type shopping cart or stroller-type shopping cart. The insert provides a work surface upon which one may write or place items, and thus is useful for stock clerks and others who may work while their store is closed, as it enables them to convert shopping carts into temporary mobile work stations.

Some prior inventors have developed devices which can be attached to a shopping cart or the like to provide alternative functionality. Representative U.S. Patents including U.S. Pat. No. 3,912,291, No. 4,643,280, No. 4,901,901, No. 4,487,134, No. 4,679,818, No. 4,702,402, No. 5,002,215 and No. 6,766,931. See also Design Patent 368,566, and published applications 2006/0006229 and 2006/0049591.

Whereas the design disclosed in U.S. Pat. No. 4,643,280 gravity mounts on the back of the shopping cart, it does not cantilever. The design shown in U.S. Pat. No. 3,912,291 does not employ a method for securing the unit to the shopping cart, but rather requires disassembly and reassembly of the handle of the shopping cart. The device described in U.S. Pat. No. 4,901,901 gravity mounts on the side of the shopping cart; it also includes flaps with fasteners to manually secure the unit to the shopping cart. Publication 2006/0006229 shows a device which mounts on the side of the shopping cart, but it does have means for securing the unit to the shopping cart. The device described in U.S. Pat. No. 4,487,134 gravity mounts to the front of the shopping cart; however, it does not employ a method for securing the unit to the shopping cart. Whereas the design of U.S. Pat. No. 4,702,402 mounts to the cross member of a shopping cart, it does provide a table top work surface. The 2006/0006229 design gravity mounts over the child seat back using a dado groove; and along the front edge of the unit against the sides of the shopping cart. The device disclosed in U.S. Pat. No. 4,679,818 mounts over the front edge of the shopping cart and secures to the rear sides using a notching method; it is not intended for transport.

Although U.S. Pat. No. 4,901,901 and Design Patent 368,566 show devices which allow portability through collapsibility, neither creates a workspace beyond the child seat area of the shopping cart. The device shown in U.S. Pat. No. 4,643,280 permits vertical storage on a flat surface only.

U.S. Pat. No. 4,487,134, No. 5,002,215, No. 4,679,818, No. 3,912,291, No. 6,766,931, No. 4,702,402, and publications US2006/0006229 and US2006/0049591 disclose devices which are portable; however, they make no provision for long or short term storage.

### SUMMARY OF THE INVENTION

An object of the invention is to enable stores to provide their employees mobile work stations without the expense and storage volume associated with dedicated work stations.

Another object is to provide a shopping cart insert which is small, light, convenient and inexpensive, and which can be easily removed and stored compactly when not in use.

The present invention offers a trash deflector to insure that all waste can be easily collected in a bag at the rear of the cart for easy disposal.

The invention employs a cantilever design which balances the weight of the device over the stroller- or basket-type shopping cart, leaving the lower front area open for storage.

The present invention is designed to better utilized existing transport systems of shopping carts in a retail environment, thus being economic and versatile. In contrast, the devices shown in publication 2002/0084628 and in U.S. Pat. Nos. 6,736,415 and 4,165,088 are individual stand-alone stroller-type or basket-type shopping carts.

One embodiment of the present invention provides alignment guides to guarantee the correct installation of the unit into the shopping cart basket. The alignment guides also make the unit secure and prevent the unit from accidentally sliding or shifting out of position, whereas the U.S. Pat. No. 4,901,901 design includes flaps to manually align the unit to the shopping cart. The design disclosed in U.S. Pat. No. 4,487,134 guarantees correct installation of the shopping cart using a notching method along the rear sides of the cart; however, the unit is not intended for transport. The U.S. Pat. No. 4,679,818 design uses stop members at the rear of the unit to guarantee the alignment into the shopping cart basket. The U.S. Pat. No. 4,643,280 design uses aligned notches to attach to the two transverse cross bars; however, it does not provide an extended cantilevered work surface, carrying handles or means to store on a wall.

Both embodiments of the invention provide portability for use and storage. The insert's slim and balanced design allows for the unit to be vertically stored behind a door, on a wall or as a stand-alone piece.

Other features and advantages of the invention will be apparent from the following description.

### BRIEF DESCRIPTION OF THE DRAWINGS

In the accompanying drawings,

FIG. 1 is a perspective view, from below, of a first work station insert embodying the invention;

FIG. 2 is a perspective view thereof, from above;

FIG. 3 is a top plan view thereof,

FIG. 4 is a left side elevation thereof,

FIG. 5 is a bottom plan view thereof, and

FIG. 6 is a perspective view showing the insert installed on a shopping cart.

FIG. 7 is a perspective view, from below, of a second embodiment of the invention;

FIG. 8 is a perspective view thereof, from above;

FIG. 9 is a top plan view thereof,

FIG. 10 is a left side elevation thereof,

FIG. 11 is a bottom plan view thereof, and

FIG. 12 is a perspective view showing the insert installed on a shopping cart.

### DESCRIPTION OF THE PREFERRED EMBODIMENT

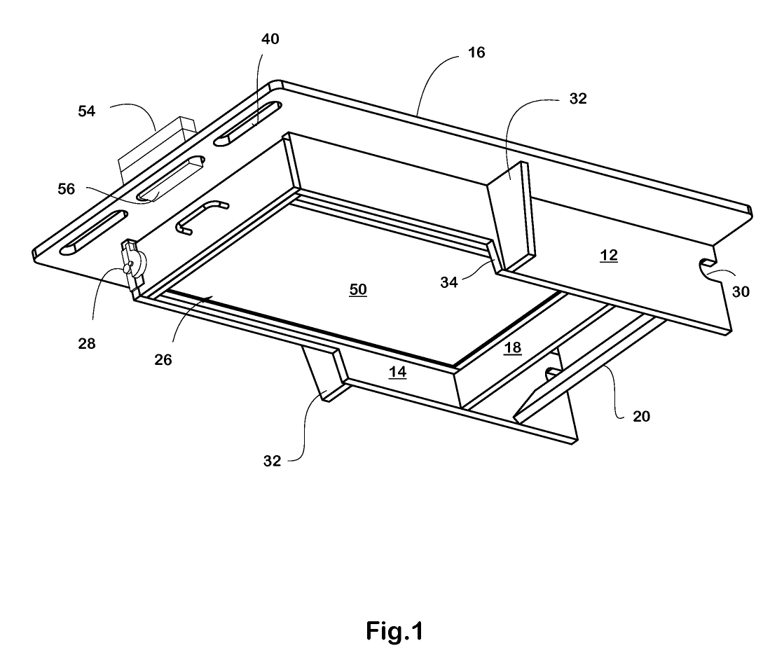

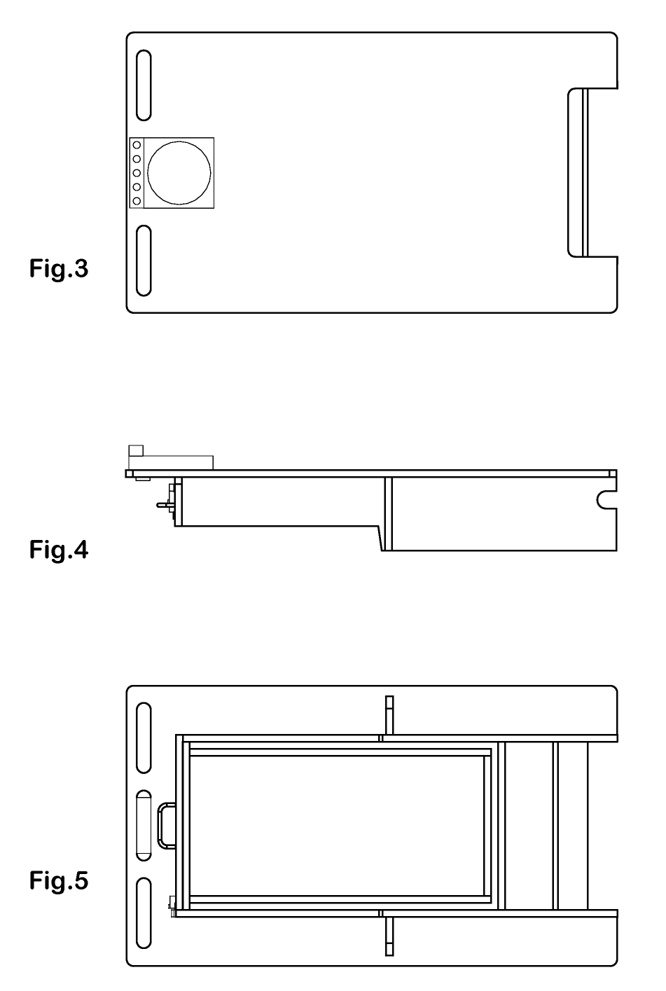

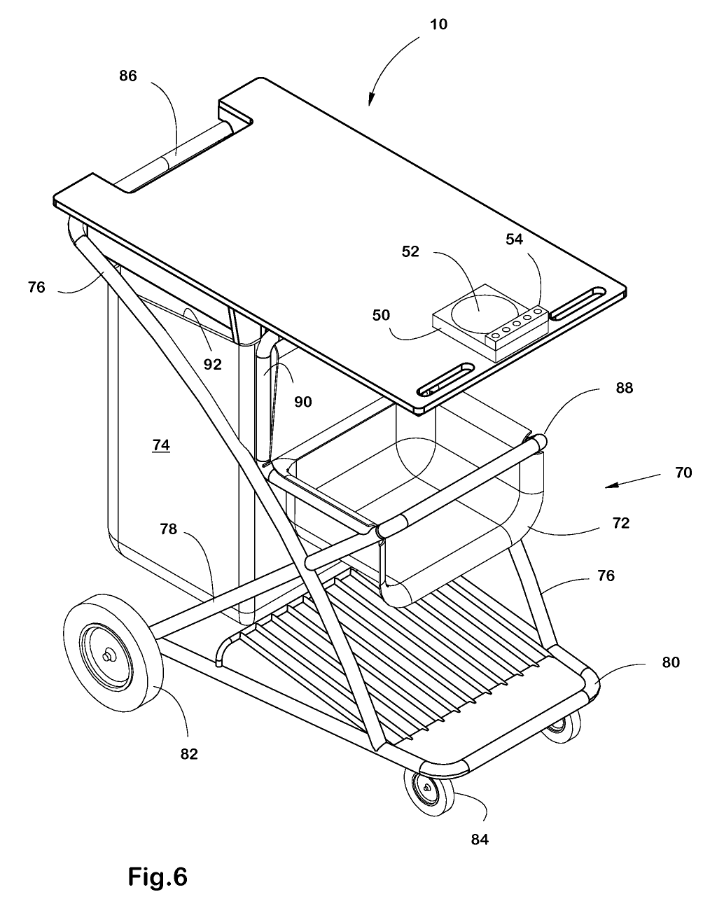

The insert 10 shown in FIGS. 1-6 is designed for a stroller-type shopping cart. The insert comprises a pair of longitudinal frame members 12,14 having top surfaces which support a horizontal table top 16. The longitudinal members are interconnected by a cross member 18 and by a trash deflector 20, the latter of which is disposed beneath a cutout 22 at the rear 24 of the table top.

As shown in FIG. 1, a sliding drawer 26 is mounted between the longitudinal members in front of the cross member 18, and beneath the table top 16. The drawer is normally held closed by a latch 28 which can be released when necessary.

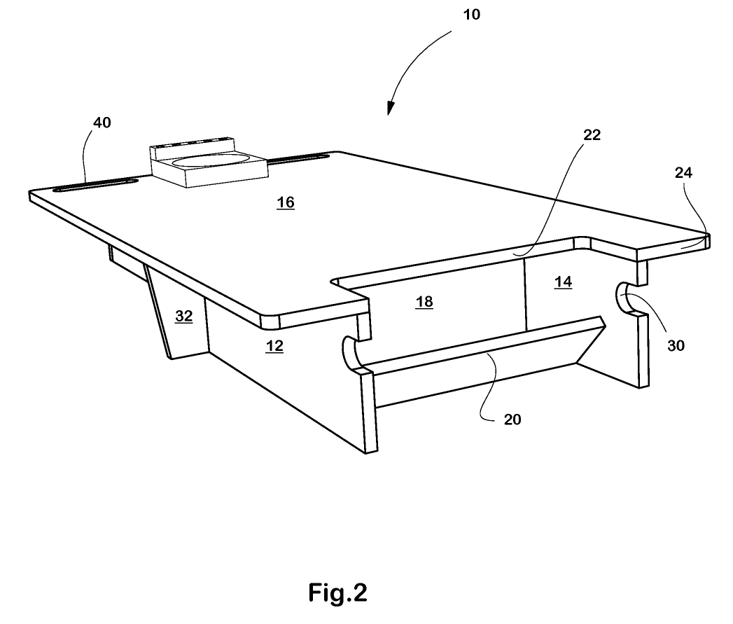

As shown in FIG. 2, a notch 30 is cut at the rear end of each longitudinal member 12, 14. The notch is sized to receive the cart handle, as described below.

A pair of downwardly tapered guide elements 32—best seen in FIG. 1—extend outward from the respective longitudinal frame elements 12, 14. The bottom edge of each longitudinal element has a step 34 at the transition between its rear portion, and its front portion, which has less height. The step provides a forward-facing shoulder for securing the insert, as described further below.

Three slots 40 are formed in the table top 16, near its front edge. These provide convenient means for pulling the cart—when the insert is on the cart—or for carrying the insert or storing the insert on a wall, when it is not.

FIG. 6 shows a removable utility tray 50 designed to hold pencils, paper clips and other items. The tray has a central depression 52, a pencil holder 54 extending upwardly from the tray, and a foot 56 (FIG. 1) designed to seat in one of the slots 40.

The stroller-type shopping cart 70 illustrated in FIG. 6 is a building products store cart, and is representative of carts with which this invention is useful. The cart has a child seat 72, so that it can also be used as a stroller, and a large flexible receptacle 74 behind the seat in which items to be purchased can be placed. The seat is supported between crossing tubes 76, 78 that extend diagonally upward from a U-shaped chassis 80 supported at its four corners by wheels 82, 84. The rearwardly inclining 76 tubes are interconnected at their upper ends by a cross tube 86 which serves as a push handle, and the forwardly inclining tubes 78 are joined by a cross tube 88 which supports the child seat at the front. A portion of the seat back is broken away in FIG. 6 to show the seat tube 90 which supports the seat, and is connected to the diagonal members 76, 78 on either side.

The receptacle 74 may be made of a strong but flexible mesh fabric. It is open and the top, and its mouth is defined by a rigid rim 92 connected both to the seat tube and to the rearwardly including tubes.

The insert, when installed on the cart, is supported by the handle 86 at its rear and by the seat tube 90 near its middle. Its guide elements 32 seat within the hoop, preventing the insert from moving laterally on the cart, and the notches 30 receive the handle 86, preventing rearward movement of the insert. Forward movement is prevented by engagement of the steps 34 with the seat tube. The taper angles of the steps and the guide elements guide the insert into its correct position as the insert is lowered.

Once in place, the insert may be used as a writing surface, being at a convenient height for that purpose. Its drawer may be used to store writing implements, papers, operational tools and the like. The optional utility tray may be stored in the drawer as well.

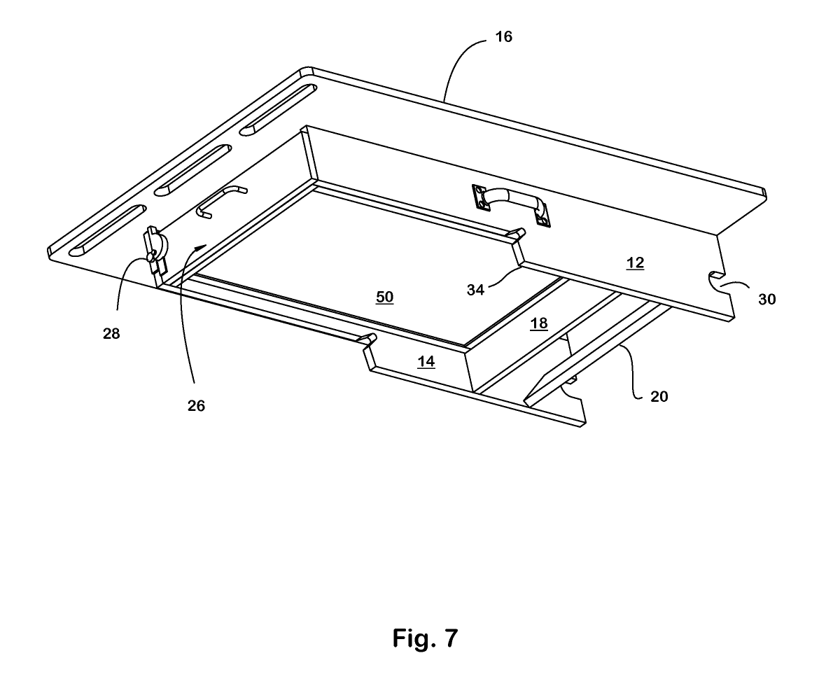

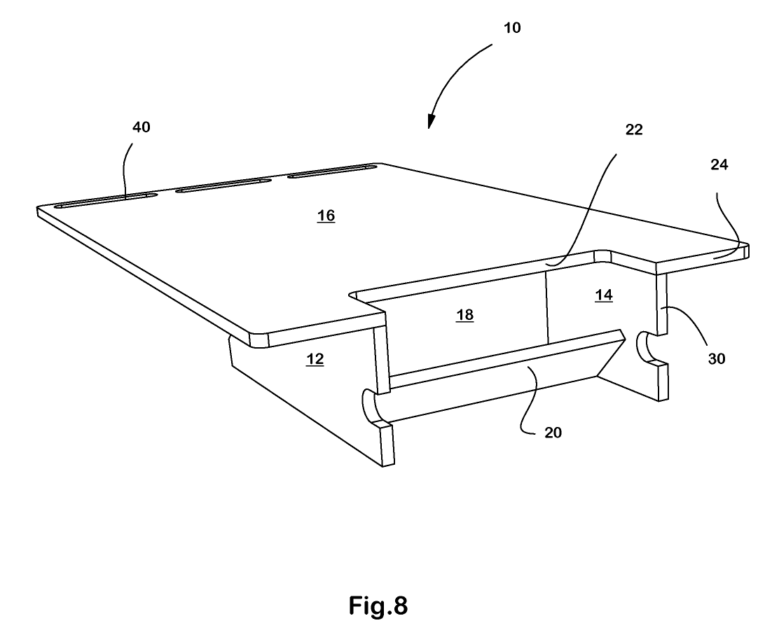

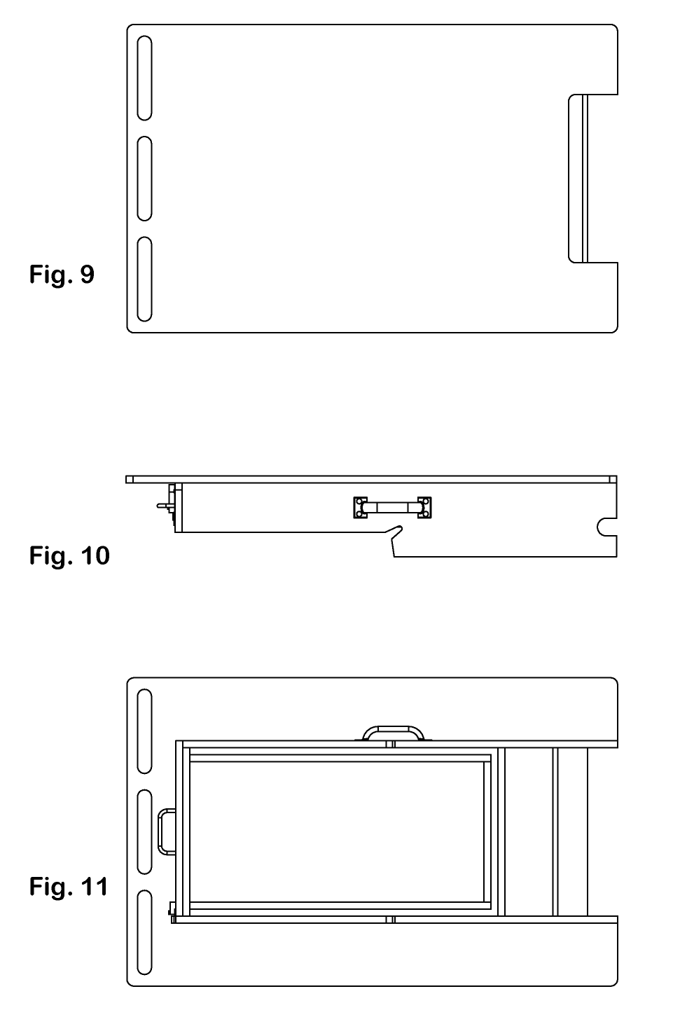

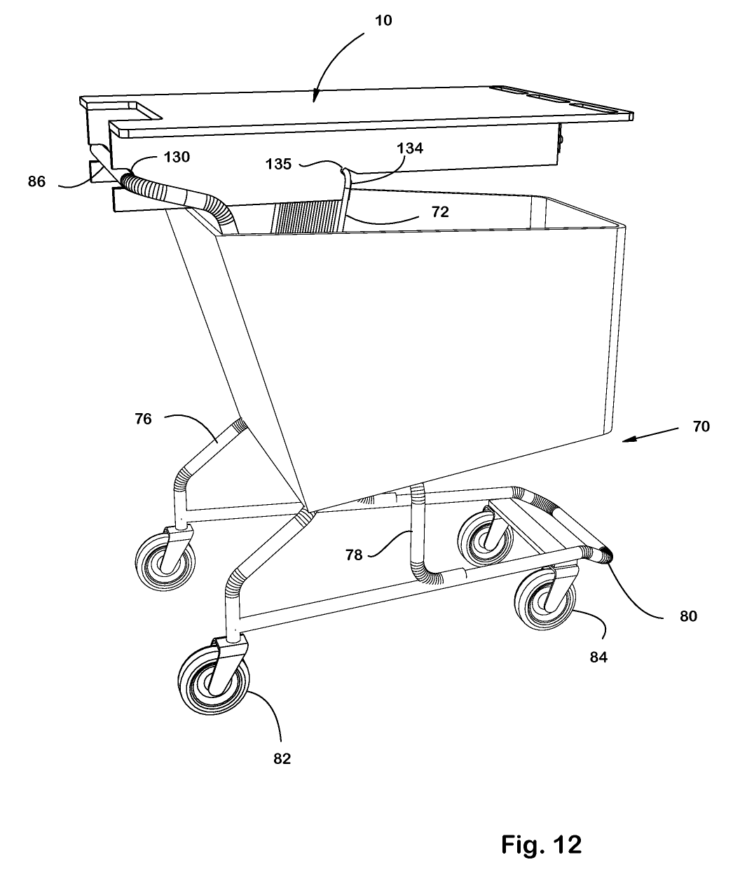

FIGS. 7-12 illustrate a second embodiment of the invention, designed for a basket-type shopping cart having a built-in child's seat. The shopping cart shown in FIG. 12 does not have a fixed child seat, but rather a structural wire panel which serves as the seat back, and can be moved from an inactive position flat against the rear of the basket to a forward, deployed position limited by the seat bottom, which acts as a stop. The top edge of the seat back, when deployed, serves to support the work station insert.

The second embodiment of the work station insert chiefly differs from the first in that it has no structure corresponding to the guide elements 32, and in that the step 134 has been modified to engage the child seat back of the basket-type cart. Also, the rear notch 130 for engaging the push handle of the cart has been moved downward, to level the table.

The insert of FIGS. 7-12 comprises a pair of longitudinal frame members 12,14 having top surfaces which support a horizontal table top 16. The longitudinal members are interconnected by a cross member 18 and by a trash deflector 20, the latter of which is disposed beneath a cutout 22 at the rear 24 of the table top.

As in the first embodiment, a notch 30 is cut at the rear end of each longitudinal member 12, 14. The notch is sized to receive the cart handle, and in this case is somewhat lower than in the first embodiment.

A second notch is cut at the step of transition in the bottom edge of each longitudinal member. This notch is sized to receive the top wire of the seat back, when the seat is deployed. The seat back supports the work station near its center, while the handle prevents the work station from tipping forward.

Unlike the first embodiment, the insert does not have (or need) structure corresponding to the guides elements 32 of the first embodiment. It may also be observed that the second embodiment is slightly wider than the first.

Since the invention is subject to modifications and variations, it is intended that the foregoing description and the accompanying drawings shall be interpreted as only illustrative of the invention defined by the following claims.

I claim:

1. A work station insert for temporary installation on a shopping cart of the type having a horizontal transverse push handle at its rear and a transverse support element associated with a child seat in front of the handle, said insert comprising
a pair of longitudinal frame members, each having a top edge, a bottom edge, a rearward end and a forward end,
each of said longitudinal frame members having a rearwardly-open slot in its rearward end for receiving the push handle and a step formed in its bottom edge for simultaneously engaging the transverse support element,
at least one cross member interconnecting the longitudinal frame members, and
a table top element supported by and connected to the upper edge of the longitudinal frame members.

2. The invention of claim 1, wherein the cart comprises a receptacle for goods, disposed behind the child seat, the receptacle having a rim, and the insert further comprises a pair of lateral guides, extending transversely outward from the respective frame members, for seating within the receptacle rim, to prevent the insert from moving laterally on the cart.

3. The invention of claim 2, wherein the lateral guides are downwardly tapered to facilitate placement of the guides within the rim.

4. The invention of claim 2, wherein the table top element has a cutout at its rear edge, and further comprising a deflector extending transversely between the longitudinal frame members rearwardly of the cross member, said deflector being angled to direct trash deposited in the cutout, between the longitudinal frame member and the deflector, into said receptacle.

5. The invention of claim 1, further comprising a sliding drawer mounted between the longitudinal frame members below the horizontal top element.

6. The invention of claim 5, further comprising a latch for securing the drawer in a closed position.

7. The invention of claim 1, wherein the step is formed by a transition between a rear portion of the longitudinal frame member and a front portion of lesser height.

8. The invention of claim 1, wherein a notch is formed in the lower edge of each longitudinal frame member adjacent the step, the notch being adapted to receive the top of a folding child seat back in the back's deployed position.

9. The invention of claim 1, wherein the table top element has plural slots formed near its forward edge to provide handholds by which one can lift or hang the insert or pull the cart.
